(19) United States
(12) Patent Application Publication
(10) Pub. No.: US 2023/0225236 A1
(43) Pub. Date: Jul. 20, 2023

(54) Agricultural Attachment for Cultivating Row Crops

(71) Applicant: Amazonen-Werke H. Dreyer SE & Co. KG, Hasbergen (DE)

(72) Inventors: Rainer RESCH, Hagen a TW (DE); Tom MAHLER, (US)

(21) Appl. No.: 18/007,883

(22) PCT Filed: May 25, 2021
(86) PCT No.: PCT/EP2021/063780

§ 371 Date: Dec. 2, 2022

(30) Foreign Application Priority Data
Jun. 5, 2020 (DE) 102020114957.3

(51) Int. Cl. A01B 69/00; A01B 69/04; G05D 1/02

(52) U.S. Cl. CPC A01B 69/001; A01B 69/008; G05D 1/0223; G05D 1/0246; G05D 2201/0201

(57) ABSTRACT

The invention relates to an agricultural attachment for cultivating row crops, comprising a row-detection device designed to detect, during a cultivation process, locations and/or courses of rows of plants on farmland, and a signal generating device designed to generate steering commands for a drive vehicle to which the attachment is attached, in accordance with the locations and/or courses of the rows of plants detected by the row-detection device.

The invention relates to an agricultural attachment for cultivating row crops according to the preamble of claim 1, to an agricultural machine assembly according to the preamble of claim 11, and to a method for cultivating row crops according to the preamble of claim 12.

In order to improve the results when cultivating farmland, plant rows are detected on the farmland during various cultivation processes. For this purpose, row-detection devices are used, which can be part of agricultural attachments, for example. Based on the row detection, a corrective movement can then be implemented on the attachment if the attachment is not optimally positioned or aligned to the plant rows.

The corrective movement on the attachment can be realized, for example, by means of a displacement frame that allows the relative position between the attachment and a drive vehicle on which the attachment is mounted to be adjusted. Document DE 10 2017 110 653 B3 discloses such a frame with a turning and displacing function.

Without technical row detection, correction of the position and alignment of the attachment relative to the plant rows has so far only been possible via manual steering intervention on the tractor or on the attachment. Steering intervention on the tractor results in a change in the direction of travel of the entire machine assembly. To perform a steering intervention on the attachment, for example, a so-called seat carrier is used for hoeing equipment, which is mounted on the hoeing equipment and on which a person can sit during a cultivation process. The person carries out manual adjustments to a displacement frame during the cultivation process in order to adjust the position of the hoeing device and its hoeing tools relative to the plant rows. Making such corrections manually, regardless of whether they are made on the tractor or the attachment, is exhausting and allows only comparatively low working speeds.

The measures proposed in the prior art for improving the result when cultivating row crops are either extremely complex and thus only of limited practical suitability or only lead to a slight improvement in the cultivation result. For example, from document WO 2019/148220 A1, a hoeing device with adjustable working width is known. Document DE 10 2016 212 201 A1 proposes the alignment of an attachment via a lower link adjustment on the tractor. Document DE 10 2017 130 694 A1 discloses a working machine with its own steering device.

The problem underlying the invention is thus to further improve the cultivation results when cultivating row crops by means of an agricultural attachment, without increasing the effort required for the cultivation.

The problem is solved by an agricultural attachment of the kind introductorily mentioned, wherein the attachment according to the invention comprises a signal generating system which is adapted to generate steering commands for a drive vehicle on which the attachment is mounted, as a function of the locations and/or courses of plant rows detected by the row-detection device.

Through the generation of steering commands, it can be achieved that the attachment positions itself in an intended manner to the plant rows and drives down the plant rows in an intended manner. The steering commands are ultimately used to cause the attachment to intervene in the steering of the drive vehicle. Based on the generation of steering commands, the machine assembly consisting of the drive vehicle and the attachment can also be caused to drive in a bend, if the plant rows each follow a curved row path within a section of the farmland. By initiating the steering intervention of the attachment on the drive vehicle, the driver of the drive vehicle is considerably relieved and the accuracy of row-related cultivation of a row crop is increased. Considerable cost savings can also be realized on the attachment, since a displacement device, such as a displacement frame, is not absolutely necessary on the attachment for aligning the attachment during cultivation and can therefore be dispensed with. However, a displacement frame offers additional advantages, particularly when driving bends, since the displacement frame can be used, for example, to precisely position the attachment when driving bends, taking into account the radius of the bend, the turning circle of the drive vehicle, and the dimensions of the attachment in the longitudinal and transverse directions. Furthermore, the drive vehicle is steered externally so that the drive vehicle does not necessarily have to have its own automatic steering system in order to be able to implement automated or partially automated cultivation. The attachment is preferably adapted to form a tractor element management (TIM) system together with a drive vehicle on which the attachment is mounted.

The signal generation device preferably comprises a data processing device, which is set up to evaluate data provided by the row-detection device and to calculate suitable steering interventions on the drive vehicle on the basis of the data evaluation. The drive vehicle can be, for example, a tractor that carries or pulls the attachment. The attachment may be adapted to be mounted at the front and/or the rear of the drive vehicle. The calculated steering interventions preferably take into account the attachment position of the attachment so that both an attachment mounted at the front of the drive vehicle and an attachment mounted at the rear of the drive vehicle can be guided precisely along the plant rows.

The signal generation device can be adapted to generate the steering commands for the drive vehicle also as a function of the dimensions and/or geometries of the drive vehicle and/or the attachment. For example, the wheelbase, turning radius and/or structural length of the drive vehicle and/or the distances of soil cultivation tools or spreading elements of the attachment to the axles of the drive vehicle can be taken into account when generating steering commands. Furthermore, the signal generation device can be adapted to generate the steering commands for the drive vehicle also as a function of tire positions, caster properties and/or pivoting properties of the attachment. The generation of steering commands can also take into account the position of a camera and/or the position of a sensor of the row-detection device. In this context, the longitudinal and/or transverse distance of the camera or sensor from the center of the drive vehicle is preferably taken into account. Corresponding data may be required for steering signal generation so that the pivot point of the attachment can be taken into account when steering the drive vehicle.

If the attachment has a displacement frame or is coupled to a displacement frame, this displacement frame can also be controlled as a function of the signals from the row-detection device. Preferably, the displacement frame has an automatic adjustment device that uses the signals from the row-detection device.

Taking into account the course and/or locations of the plant rows, the relative position between the displacement frame and the drive vehicle can then always be optimally adjusted. A displacement frame thus allows positioning of the soil cultivation tools or the spreading elements of the attachment during driving in a bend, which takes into account the bend radius, the turning radius of the drive vehicle and the dimensions of the attachment in the longitudinal and transverse directions.

In a preferred embodiment, the agricultural attachment according to the invention has a communication device which is adapted to exchange data bidirectionally with a control unit of the drive vehicle. The steering commands for the drive vehicle generated by the signal generation device can be transmitted to the drive vehicle via the communication device. The data exchange between the communication device of the attachment and the control unit of the drive vehicle can be wired or wireless. A bus system of the drive vehicle can be used for communication between the communication device of the attachment and the control unit of the drive vehicle, wherein the generated steering commands are transmitted in this case, for example, as bus messages to the control unit of the drive vehicle.

In a further preferred embodiment, the agricultural attachment according to the invention has a plurality of soil cultivation tools spaced apart from one another transversely to the direction of travel. The signal generation device is preferably adapted to generate the steering commands for the drive vehicle for correcting relative positions between plant rows and soil cultivation tools. The attachment can be a hoe, for example. The soil cultivation tools can be hoeing tools, for example. Deviations between the target positions and the actual positions of the soil cultivation tools are compensated for by the steering of the drive vehicle, which is caused by the generated steering commands.

In another preferred embodiment, the agricultural attachment according to the invention comprises a plurality of spreading elements spaced apart transversely to the direction of travel, wherein the signal generation device is arranged to generate the steering commands for the drive vehicle to correct relative positions between plant rows and spreading elements. The attachment may be, for example, a crop protection sprayer. The spreading elements may be spray nozzles. The spray nozzles of a crop protection sprayer are usually arranged above the plant rows. The spray liquid applied is often intended to treat only a band of plants and not the entire plant stand, so that precise positioning of the spray nozzles relative to the plant rows is required. Deviations between the target positions and the actual positions of the spreading elements are compensated for via the steering of the drive vehicle. The attachment can also have a steerable axle so that deviations between the target positions and the actual positions of the spreading elements can be compensated alternatively or additionally via the steering of the attachment.

Furthermore, an agricultural attachment according to the invention is preferred, in which the signal generation device is arranged to generate speed setting commands for the drive vehicle. Through the speed setting commands, the attachment can cause a change in the travel speed of the drive vehicle. Thus, for example, the attachment can cause a reduction in speed when driving the machine assembly in a bend is required or when row detection is imprecise. Reducing the speed also provides the operator with the opportunity to manually intervene in the control of the attachment and/or the drive vehicle. Appropriate bend driving may be required if the plant rows follow arcuate row paths, for example in the edge area of a farmland or in the vicinity of an obstacle.

The agricultural attachment according to the invention is further preferably further embodied in that the signal generation device is adapted to generate speed setting commands for the drive vehicle as a function of the locations and/or courses of plant rows detected by the row-detection device. If a straight row course is detected, the travel speed of the drive vehicle can be increased without impairing the cultivation result, since in this case few steering interventions are required. If a curved or arc-shaped row course is detected, the travel speed of the drive vehicle can be reduced to avoid affecting the cultivation result. In this case, the travel speed must be reduced to such an extent that the movement path of the drive vehicle and the attachment can be adapted to the course of the row within a tolerance range by means of steering interventions. A reduction in the travel speed may be necessary in particular if the control speed of the drive vehicle is not sufficient to be able to implement the necessary steering interventions in good time.

The agricultural attachment can be predetermined a permissible speed range within which an automatic adjustment of the travel speed by the attachment can be initiated. The permissible speed range can be predefined at the factory and/or can be set by the operator. By specifying the permissible speed range, excessive travel speeds in particular are avoided, which can lead to impairment of the cultivation result, for example by excessive burial due to excessive earth movement.

Alternatively or additionally, the signal generation device may be adapted to generate the speed setting commands for the drive vehicle as a function of a control speed of the drive vehicle and/or the direction of movement of the attachment relative to the detected plant rows. If the drive vehicle has a comparatively low control speed, the travel speed of the drive vehicle must be adapted to the sluggish control behavior. The higher the control speed of the drive vehicle, the higher the travel speed of the drive vehicle can be set, since the responsiveness of the machine assembly also increases with the control speed of the drive vehicle.

Furthermore, an agricultural attachment according to the invention is preferred, which comprises an evaluation device, wherein the evaluation device is adapted to evaluate the result of the cultivation of the row crops during a cultivation process with regard to at least one cultivation criterion dependent on the driving speed. In the case of hoeing, for example, the degree of burial of the plants by the upturned earth stream represents a processing criterion dependent on travel speed. If the travel speed is too high, the plants will be buried to an unintended degree by the upturned earth stream. In this case, the evaluation device can be adapted to detect the degree of burial of the plants, wherein the detection of the degree of burial can, for example, be camera-based and/or sensor-based. The signal generation device is preferably adapted to generate speed setting commands for the drive vehicle depending on the result of the cultivation of the row crops evaluated by the evaluation device. The travel speed is therefore adjusted depending on the quality of the work achieved. If the cultivation result is outside an acceptable tolerance range, the signal generation device preferably causes the travel speed to be reduced. If the cultivation result is within a tolerance range, the signal generation device can cause the travel speed to be increased so that the cultivation time is reduced. The evaluation device can be integrated into the row-detection device. Furthermore, the evaluation device can use one or more cameras and/or one or more sensors of the row-detection device to evaluate the cultivation result.

In a further embodiment, the agricultural attachment according to the invention comprises a rotation rate sensor which is adapted to detect a change in alignment of the attachment relative to the longitudinal direction of the plant rows, wherein the row-detection device is adapted to detect the locations and/or courses of plant rows on the farmland taking into account the change in alignment of the attachment detected by the rotation rate sensor. Steering movements on the drive vehicle result in a change of alignment and thus a skewing of the attachment. The skew affects the row detection, for example due to the skew of one or more cameras or one or more sensors. The skewing of a camera results in a changed acquisition angle. The skewing of a sensor results in a changed detection angle. The changed acquisition and/or detection angles can distort the row detection. The sensor data from the rotation rate sensor is provided to the row detection so that the camera images or sensor data can be corrected taking into account the change in alignment of the attachment. The rotation rate sensor may be a yaw rate sensor, for example.

In a further preferred embodiment, the agricultural attachment according to the invention comprises an inclination sensor which is arranged to detect an inclination of the attachment relative to a horizontal axis, the soil of the farmland, a leaf canopy and/or a crop top. The signal generation device is preferably adapted to generate steering commands for the drive vehicle also as a function of the inclination of the attachment detected by the inclination sensor. When cultivating on a slope, this enables early slope countercorrection, if the drive vehicle threatens to slip away on the slope or has already slipped away. The inclination sensor allows early detection of a drift situation so that the drift of the machine assembly on the slope can be counteracted at an early stage via a steering intervention.

The row-detection device can also be adapted to detect the locations and/or courses of plant rows on the farmland, taking into account the inclination of the attachment detected by the inclination sensor. When cultivating on a slope, an angle of inclination is established on the drive vehicle and the attachment. The inclination affects the row detection, for example by an associated inclination of one or more cameras and/or one or more sensors. This leads to changed acquisition or detection angles, so that the row detection is distorted. The sensor data of the inclination sensor is made available to the row-detection device so that the camera images or sensor data can be evaluated taking into account the current device inclination.

In another preferred embodiment of the agricultural attachment according to the invention, the row-detection device comprises one or more cameras for row detection. Alternatively or additionally, the row-detection device comprises one or more sensors for row detection. Alternatively or additionally, the row-detection device comprises one or more sensors for row detection. The sensors can be ultrasonic sensors, for example. The row sensors can be used, for example, for row detection in a plant stand where stable plant stems are present. Thus, a row-detection device with one or more row sensors can be used, in particular, for row detection in a corn crop. Furthermore, the agricultural attachment can be adapted to detect real-time kinematics (RTK) signals so that the steering commands for the drive vehicle can also be generated taking into account the detected RTK signals.

Furthermore, a groove could be made in the soil of the farmland during sowing, wherein the groove runs equidistant to a plant row, for example. The groove created during the sowing process can then be detected, for example, with a sensing wheel of the row-detection device. The sensing wheel preferably has a sensor so that the courses and/or locations of the plant rows can be determined via the sensory detection of the groove created during sowing.

The problem underlying the invention is further solved by an agricultural machine assembly of the kind introductorily mentioned, wherein the agricultural attachment of the agricultural machine assembly according to the invention is configured according to one of the embodiments described above and the drive vehicle is adapted to automatically execute a steering operation on the basis of steering commands from the attachment. With regard to the advantages and modifications of the agricultural machine assembly according to the invention, reference is first made to the advantages and modifications of the attachment according to the invention.

The drive vehicle can be a tractor, for example. The drive vehicle is preferably adapted to automatically adjust the travel speed on the basis of speed setting commands from the attachment. The agricultural machine assembly is thus controlled automatically on the basis of the row detection so that no steering and/or speed setting interventions are required by the driver of the drive vehicle during the cultivation of the farmland.

The problem underlying the invention is further solved by a method of the kind introductorily mentioned, wherein, within the framework of the method according to the invention, steering commands for a drive vehicle of the machine assembly, on which the attachment is mounted, are generated by means of a signal generation device of the attachment as a function of the locations and/or courses of plant rows detected by the row-detection device. The steering commands generated by the signal generation device are then transmitted to a control unit of the drive vehicle. The drive vehicle then automatically performs a steering operation based on the transmitted steering commands from the attachment. The method for cultivating row crops according to the invention is preferably carried out by means of an agricultural machine assembly according to one of the embodiments described above and/or using an agricultural attachment according to one of the embodiments described above.

In a preferred embodiment of the method according to the invention, speed setting commands for the drive vehicle are generated by means of the signal generation device of the attachment. The speed setting commands are preferably generated as a function of the locations and/or courses of plant rows detected by the row-detection device. The speed setting commands generated by the signal generation device are preferably transmitted to a control unit of the drive vehicle so that the drive vehicle can automatically set the travel speed on the basis of the transmitted speed setting commands of the attachment.

Furthermore, a method according to the invention is preferred, in which the result of the cultivation of the row crops during a cultivation process is evaluated with regard to at least one cultivation criterion dependent on driving speed by means of an evaluation device of the attachment. The speed setting commands for the drive vehicle are preferably generated as a function of the result of the cultivation of the row crops evaluated by the evaluation device. Alternatively or additionally, a change in the alignment of the attachment relative to the longitudinal direction of the plant rows is detected by means of a rotation rate sensor of the attachment. The detection of the locations and/or courses of plant rows on the farmland is preferably carried out taking into account the change in the alignment of the attachment detected by the rotation rate sensor.

In the following, preferred embodiments of the invention are explained and described in more detail with reference to the accompanying drawings. Therein:

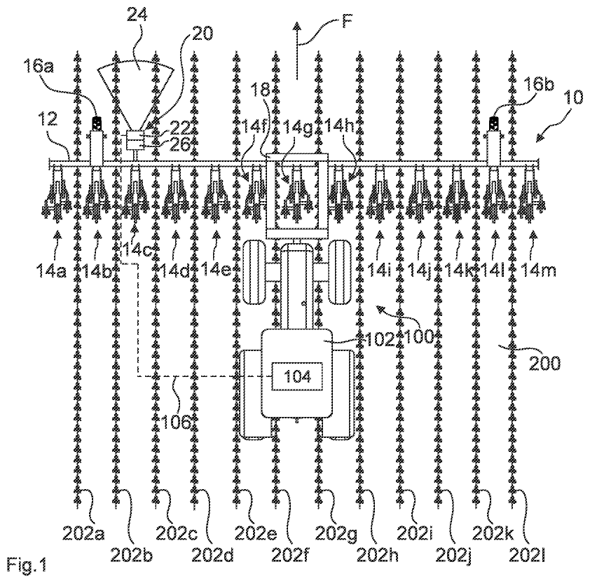

FIG. 1 shows an embodiment of the agricultural machine assembly according to the invention during the cultivation of a farmland in a top view;

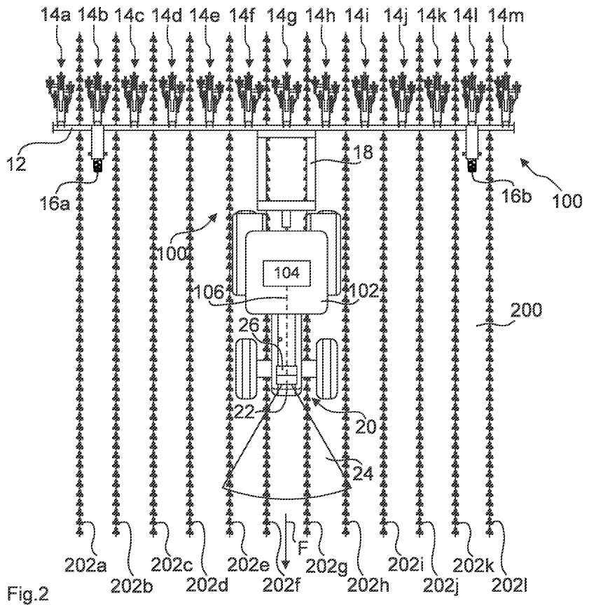

FIG. 2 shows a further embodiment of the agricultural machine assembly according to the invention during the cultivation of a farmland in a top view;

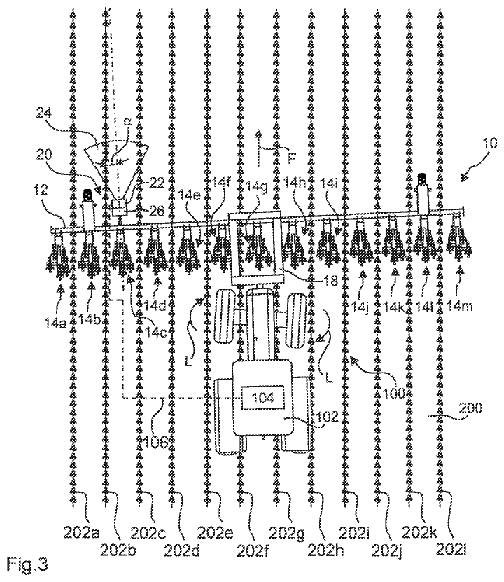

FIG. 3 shows another embodiment of the agricultural machine assembly according to the invention during cultivation of a farmland in a top view; and

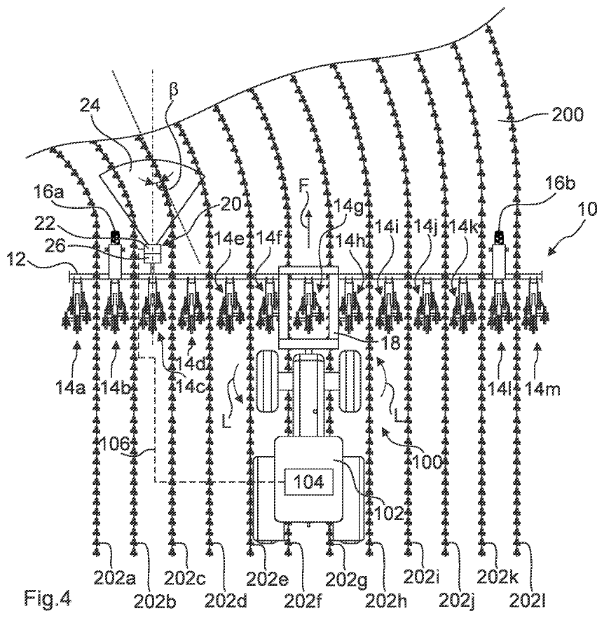

FIG. 4 shows a further embodiment of the agricultural machine assembly according to the invention during the cultivation of a farmland in a top view.

FIG. 1 shows an agricultural machine assembly 100 having a drive vehicle 102 and an agricultural attachment 10. The drive vehicle 102 is a tractor, and the attachment 10 is mounted to a front coupling device of the drive vehicle 102. The attachment 10 is an agricultural hoe having a plurality of soil cultivating tools 14a-14m spaced equidistantly apart from each other. The soil cultivating tools 14a-14m are arranged side by side and equidistantly spaced apart from each other transversely to the direction of travel F. The soil cultivating tools 14a-14m are hoeing tools, which are attached to a cross member 12 of the attachment 10 extending transversely to the direction of travel F.

The cross member 12 is supported relative to the ground of the farmland 200 via the wheels 16a, 16b of the attachment 10. The cross member 12 is connected to the front coupling device of the drive vehicle 102 via an adjustment device 18 in the form of a displacement frame.

The adjustment device 18 may include one or more adjustment drives by which the cross member 12 may be moved and/or pivoted longitudinally and/or transversely to position the soil cultivating tools 14a-14m centrally between the plant rows 202a-202l. Further, the soil cultivating tools 14a-14m may be movable along the cross member 12 and/or pivotable relative to the cross member 12.

The attachment 10 is equipped with a row-detection device 20, via which the locations and courses of the plant rows 202a-202l on the farmland 200 can be detected during a cultivation process. The row-detection device 20 comprises a camera 22 for row detection. Alternatively or additionally, the row detection device 20 could also comprise one or more sensors and/or one or more sensing devices for row detection. The camera 22 has an imaging area 24, wherein the locations and courses of the plant rows 202b, 202c located in the imaging area 24 can be detected by the row-detection device 22. The location and course detection of the plant rows 202b, 202c is performed by an evaluation of the image recordings acquired by the camera 22.

The agricultural attachment 10 may include a rotation rate sensor for sensing a change in the alignment of the attachment 10 relative to the longitudinal direction of the plant rows 202a-202l. The change in alignment of the attachment 10 for results in a skewed position of the attachment 10, which changes the angle of view of the camera 22. Through the change in the alignment of the attachment 10 detected by the rotation rate sensor, the changed shooting angle of the camera 22 can be taken into account in the row detection so that the courses and locations of the plant rows 202b, 202c are determined with a higher degree of precision. Thus, the camera images of the camera 22 are evaluated taking into account the current skewed position of the attachment 10 and thus taking into account the current skewed position of the camera 22.

The agricultural attachment 10 further includes a signal generation device 26 that generates steering commands for the drive vehicle 102. The steering commands generated by the signal generation device 26 are transmitted to a control unit 104 of the drive vehicle 102 via the data link 106. For this purpose, the attachment 10 comprises a communication device that allows bidirectional data exchange with the control unit 104 of the drive vehicle 102. The data link 106 may be a wired data link or a wireless data link.

The signal generation device 26 generates the steering commands for the drive vehicle 102 as a function of to the locations and courses of the plant rows 202b, 202c detected by the row-detection device 20. Through the steering command generation, it is achieved that the attachment 10 traverses the plant rows 202a-202l of the farmland 200 in an intended manner, namely such that the soil cultivating tools 14a-14m are always arranged centrally between the plant rows 202a-202l. The steering commands generated by the signal generation device 26 ultimately cause a steering intervention on the drive vehicle 102 initiated by the attachment 10. Consequently, the drive vehicle 102 is steered externally so that no manual steering intervention by the vehicle driver is required. Furthermore, a lane detection system can be dispensed with on the drive vehicle 102, since an automatic steering system exclusively on the vehicle side is not required. The machine assembly 100 consisting of the drive vehicle 102 and the attachment 10 thus forms a so-called tractor implement management system.

When generating steering commands, the signal generation device 26 may take into account the dimensions and/or geometries of the drive vehicle 102 and/or the attachment 10. Further, the signal generation device 26 may take into account tire positions, caster properties, and/or pivot characteristics of the attachment 10 when generating steering commands.

The row-detection device 20 is attached to the cross member 12 of the attachment 10 and aligned in the direction of travel F. The detection range of the row-detection device 20 is arranged in front of the soil cultivating tools 14a-14m in the direction of travel F.

FIG. 2 also shows a machine assembly 100 comprising a drive vehicle 102 configured as a tractor and an attachment 10 configured as a hoe. In the embodiment shown, the attachment 10 is mounted on a rear coupling device of the drive vehicle 102.

In this case, the row-detection device 20 of the attachment 10 is arranged in a front area of the drive vehicle 102. For example, the row-detection device 20 is reversibly and non-destructively detachably attached to an engine cover of the drive vehicle 102. Alternatively, the row-detection device 20 may be reversibly and non-destructively detachably attached to the roof or a front power lift of the drive vehicle 102. The camera 22 of the row-detection device 20 is aligned in the direction of travel F, wherein the plant rows 202e-202h are located in the imaging area 24 of the camera 22. Via an image evaluation of the camera recordings, the locations and courses of the plant rows 202e-202h can be determined during the cultivation process.

The row-detection device 20 is again connected to a control unit 104 of the drive vehicle 102 via a communication module so that steering commands for the drive vehicle 102 generated by the signal generation device 26 can be transmitted to the drive vehicle 102 via the data link 106.

The signal generation device 26 is further adapted to generate speed adjustment commands for the drive vehicle 102. The speed adjustment commands are generated as a function of the locations and courses of the plant rows 202e-202h detected by the row-detection device 20. Consequently, through the speed adjustment commands, the attachment 10 can cause a change in the travel speed of the drive vehicle 102. When a straight row course is detected, the travel speed of the drive vehicle 102 can be increased without affecting the cultivation result because few critical steering interventions are required in this case. When a curved row course is detected, the travel speed of the drive vehicle 102 can be reduced to avoid affecting the cultivation result. In this case, the travel speed should be reduced at least enough to achieve a cultivation result that is within a tolerance range through steering interventions.

In order to check whether the cultivation result is within a tolerance range, the attachment 10 may further comprise an evaluation device, via which the result of the cultivation of the row crops during the cultivation process is evaluated with respect to a driving speed-dependent evaluation criterion. The evaluation device may be adapted to determine the degree of burial of the crops by the soil flow thrown up during the cultivation. The degree of burial of the plants by the thrown-up earth stream must not leave a tolerance range during the cultivation process. In the event that the degree of burial of the plants by the thrown-up earth stream leaves the tolerance range, the signal generation device 26 generates a speed adjustment command which results in a reduction in the travel speed of the drive vehicle 102.

FIG. 3 shows an undesirable skewed alignment of the soil cultivating tools 14a-14m with respect to the longitudinal axes of the plant rows 202a-202l. The skewed orientation a of the soil cultivating tools 14a-14m also results in the soil cultivating tools 14a-14m not being positioned centrally between the plant rows 202a-202l.

This mispositioning of the soil cultivating tools 14a-14m with respect to the plant rows 202a-202ₗ is detected by the row-detection device 20 of the attachment 10. Based on the row detection that has occurred, the signal generation device 26 generates steering commands that are transmitted to a control unit 104 of the drive vehicle 102 via the data link 106. Based on the steering commands received, the control unit 104 causes a steering movement L at the front axle of the drive vehicle 102. Via the steering movement L at the front axle of the drive vehicle 102, a correction of the positioning of the soil cultivating tools 14a-14m is effected so that the soil cultivating tools 14a-14m again move centrally between the plant rows 202a-202l through the soil of the farmland 200 without skewing. The steering intervention on the drive vehicle 102 caused by the attachment 10 provides for the elimination of the skew a.

FIG. 4 shows a machine assembly 100 during cultivation of a farmland 200, wherein the machine assembly 100 approaches a bend section in which the plant rows 202a-202l follow bent row paths. In the bend section, there is a changing differential angle 13 between the longitudinal axis of the machine assembly 100 and the tangents that can be applied to the plant rows 202a-202l.

Through the row-detection device 20, the attachment 10 is capable of detecting the curved or arcuate path of the plant rows 202b-202d at an early stage and deriving the radius of the bend based on the path of the plant rows 202b-202d so that steering commands for the drive vehicle 102 can be generated through the signal generation device 26, taking into account the advance speed and control speed. The steering commands generated by the signal generation device 26 are transmitted to the drive vehicle 102 via the data link 106, wherein the drive vehicle 102 implements the steering commands so that a steering movement L is executed at the front axle of the drive vehicle 102. Through the steering movement L, the soil cultivating tools 14a-14m remain centered between the plant rows 202a-202l at all times, even within the bend area, without requiring manual steering intervention by the operator of the vehicle.

### LIST OF REFERENCE SIGNS

10 attachment
12 cross member
14a-14m soil cultivating tools
16a, 16b wheels
18 adjustment device
20 row-detection device
22 camera
24 imaging area
26 signal generation device
100 machine assembly
102 drive vehicle
104 control unit
106 data link
200 farmland
202a-202l plant rows
F direction of travel
L steering movement
α skew
β differential angle

1. An agriculture attachment for cultivating row crops, comprising
a row-detection device adapted to detect, during a cultivation process, locations and/or courses of rows of plants on farmland;
characterized by a signal generating device adapted to generate steering commands for a drive vehicle to which the attachment is attached, in accordance with the locations and/or courses of the rows of plants detected by the row-detection device.

2. The agricultural attachment of claim 1,
characterized by a communication device which is adapted to exchange data bidirectionally with a control unit the drive vehicle,
wherein the steering commands for the drive vehicle generated by the signal generation device can be transmitted to the drive vehicle the communication device.

3. The agricultural attachment of claim 1,
characterized by a plurality of soil cultivating tools spaced apart transversely to the direction of travel,
wherein the signal generation device is adapted to generate the steering commands for the drive vehicle to correct relative positions between plant rows and soil cultivating tools.

4. The agricultural attachment of claim 1,
characterized by a plurality of spreading elements spaced apart transversely to the direction of travel, wherein the signal generation device is adapted to generate the steering commands for the drive vehicle to correct relative positions between plant rows and spreading elements.

5. The agricultural attachment of claim 1,
characterized in that the signal generation device is adapted to generate speed setting commands for the drive vehicle.

6. The agricultural attachment of claim 5,
characterized in that the signal generation device is adapted to generate speed adjustment commands for the drive vehicle as a function of the locations and/or courses of plant rows detected by the row detection device.

7. The agricultural attachment of claim 5,
characterized by an evaluation device which is adapted to evaluate the result of the cultivation of the row crops during a cultivation process with regard to at least one cultivation criterion which is dependent on the driving speed,
wherein the signal generation device is adapted to generate speed setting commands for the drive vehicle as a function of the result of the processing of the row crops evaluated by the evaluation device.

8. The agricultural attachment of claim 1,
characterized by a rotation rate sensor adapted to detect a change in alignment of the attachment relative to the longitudinal direction of the plant rows,
wherein the row-detection device is adapted to detect the locations and/or courses of plant rows on the farmland taking into account the change in alignment of the attachment detected by the rotation rate sensor.

9. The agricultural attachment of claim 1,
characterized by an inclination sensor which is adapted to detect an inclination of the attachment relative to a horizontal plane, the ground of the farmland, a leaf canopy and/or a crop top,
characterized in that the signal generation device is adapted to generate the steering commands for the drive vehicle also as a function of the inclination of the attachment detected by the inclination sensor.

10. The agricultural attachment of claim 1,
characterized in that the row-detection device comprises one or more cameras, one or more sensors and/or one or more sensing devices for row detection.

11. The agricultural machine assembly, comprising
an agricultural attachment; and
a drive vehicle on which the attachment is mounted;
characterized in that the agricultural attachment is configured according to one of the preceding claims, and the drive vehicle is adapted to automatically perform a steering operation based on steering commands from the attachment.

12. A method for cultivating row crops by means of an agricultural machine assembly of claim 11, comprising the step:
detecting locations and/or courses of plant rows on a farmland during a cultivation process by means of a row-detection device of an agricultural attachment of the agricultural machine assembly;
characterized by the steps of:
generating steering commands for a drive vehicle of the machine assembly, on which the attachment is mounted, as a function of the locations and/or courses of plant rows detected by the row-detection device y means of a signal generation device of the attachment;
transmitting steering commands generated by the signal generation device to a control unit of the drive vehicle; and
automatic execution of a steering operation by the drive vehicle based on the transmitted steering commands of the attachment.

13. The method of claim 12,
characterized by the step of:
generating speed setting commands for the drive vehicle by means of the signal generation device of the attachment;
wherein generating said speed setting commands is preferably performed as a function of locations and/or courses of plant rows detected by said row-detection device.

14. The method of claim 13,
characterized by the step of:
evaluating the result of the cultivation of the row crops during a cultivation process with regard to at least one cultivation criterion dependent on the driving speed by means of an evaluation device of the attachment;
wherein the generation of the speed setting commands for the drive vehicle preferably takes place as a function of the result of the cultivation of the row crops evaluated by the evaluation device.

15. The method of claim 12,
characterized by the step of:
detecting a change in the alignment of the attachment relative to the longitudinal direction of the plant rows by means of a rotation rate sensor of the attachment,
wherein detecting the locations and/or courses of plant rows on the farmland is performed taking into account the change in alignment of the attachment detected by the rotation rate sensor.
